(19) United States
(12) Patent Application Publication
(10) Pub. No.: US 2024/0198822 A1
(43) Pub. Date: Jun. 20, 2024

(54) MOUNTING STRUCTURE OF CHARGER CONNECTION MODULE FOR VEHICLE

(71) Applicants: Hyundai Motor Company, Seoul (KR); Kia Corporation, Seoul (KR)

(72) Inventors: Seung Woo HAN, Hwaseong-si (KR); Hyung Tae KIM, Seoul (KR); Mun Tae SON, Seongnam-si (KR)

(73) Assignees: Hyundai Motor Company, Seoul (KR); Kia Corporation, Seoul (KR)

(21) Appl. No.: 18/243,817

(22) Filed: Sep. 8, 2023

(30) Foreign Application Priority Data
Dec. 14, 2022 (KR) 10-2022-0174554

(51) Int. Cl. B60L 53/16; B60L 53/34; H01M 50/249

(52) U.S. Cl. CPC B60L 53/16; B60L 53/34; H01M 50/249

(57) ABSTRACT

A charger connection module for a vehicle configured in a structure having sufficient stiffness and durability to withstand loads applied in various directions, includes a mounting bracket provided with the charger connection module to which an external electric charger of a vehicle is selectively connectable, wherein a front portion of the mounting bracket is bonded to a quarter internal panel, and a rear portion of the mounting bracket is bonded to a side external extension panel positioned behind the quarter internal panel.

### CROSS-REFERENCE TO RELATED APPLICATION

The present application claims priority to Korean Patent Application No. 10-2022-0174554 filed on Dec. 14, 2022, the entire contents of which is incorporated herein for all purposes by this reference.

### BACKGROUND OF THE PRESENT DISCLOSURE

### Field of the Present Disclosure

The present disclosure relates to a mounting structure of a charger connection module for a vehicle, and specifically, to a mounting structure of a charger connection module for a vehicle having sufficient stiffness and durability.

### Description of Related Art

In general, electric vehicles are provided with a charging inlet on a vehicle body for electric charging. In electric vehicles derived from internal combustion engine vehicles, the charging inlet is positioned on a front of the vehicle, and in electric vehicles to which a dedicated platform for electric vehicles is applied, the charging inlet is positioned on a rear right side of the vehicle.

The charging inlet is normally closed by a charging inlet door and opened upon charging. A charger connection module to which an external electric charger may be connected is positioned inside the charging inlet.

Because the electric vehicles use electrical energy as a power source, the electric charger needs to be plugged to and unplugged from the charger connection module many times. At the instant time, as the electric charger is inserted into the charger connection module, a load due to the movement of the electric charger is applied to the charger connection module. When the electric charger is incorrectly inserted into the charger connection module, loads in all directions are applied to the charger connection module in a process of accurately aligning the electric charger to a correct position of the charger connection module.

Because the load applied to the charger connection module is transmitted to a mounting structure of supporting the charger connection module, it is necessary to mount the charger connection module on the vehicle body in a structure having sufficient stiffness and durability.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a mounting structure of a charger connection module for a vehicle configured in a structure having sufficient stiffness and durability to withstand loads applied in various directions.

The object of the present disclosure is not limited to the above-described object, and other objects of the present disclosure, which are not mentioned, will be able to be clearly understood by those skilled in the art to which the present disclosure pertains from the following description.

The present disclosure provides a mounting structure of a charger connection module for a vehicle including a mounting bracket for the charger connection module provided with the charger connection module to which an external electric charger of a vehicle is selectively connectable, wherein a front portion of the mounting bracket is attached to a quarter internal panel, and a rear portion of the mounting bracket is attached to a side external extension panel positioned behind the quarter internal panel.

According to an exemplary embodiment of the present disclosure, the mounting bracket may include a bracket center portion extending in a longitudinal direction, a bracket front portion bent and extending from a front end portion of the bracket center portion in a transverse direction, a bracket rear portion bent and extending from a rear end portion of the bracket center portion in a same direction as the bracket front portion, a front flange bent and extending forward from a distal end portion of the bracket front portion, and a rear flange bent and extending rearward from a distal end portion of the bracket rear portion.

Furthermore, the front flange may be attached to the quarter internal panel. The front flange may be attached to a flange of the quarter internal panel and a flange of a wheel housing internal panel attached to the flange of the quarter internal panel.

Furthermore, the bracket rear portion may be attached to a transverse extension of the side external extension panel, and the rear flange may be attached to a longitudinal extension of the side external extension panel. Furthermore, the transverse extension may extend in the same direction as the bracket rear portion, and the longitudinal extension may be bent and may extend rearward from a distal end portion of the transverse extension. Furthermore, the rear flange may be positioned between the longitudinal extension and the flange of the quarter internal extension panel and attached to both of the longitudinal extension and the flange of the quarter internal extension panel.

Furthermore, the front flange may include a vertical height lower than a vertical height of the rear flange. Furthermore, the bracket center portion may include a structure bent in a “U” shape. Furthermore, the charger connection module may be mounted on the bracket center portion through a plurality of fastening members.

Furthermore, the quarter internal panel and the side external extension panel may be attached to a side external panel. Furthermore, an upper portion of the quarter internal extension panel may be attached to the side external panel, and a lower portion of the quarter internal extension panel may be attached to the side external extension panel.

According to the above configuration, in an exemplary embodiment of the present disclosure, it is possible to secure sufficient stiffness and durability configured for withstanding the loads applied to the charger connection module in various directions normally and upon charging.

Furthermore, according to an exemplary embodiment of the present disclosure, because a mounting bracket for a charger connection module connecting a quarter internal panel and a side external extension panel is configured to reinforce the stiffness of the vehicle body, it is also possible to improve the overall vehicle body frame.

The effects of the present disclosure are not limited to the above-described effects, and other effects of the present disclosure which are not mentioned, will be able to be clearly understood by those skilled in the art to which the present disclosure pertains from the following description.

It is understood that the term “automotive” or “vehicular” or other similar term as used herein is inclusive of motor automotives in general such as passenger vehicles including sports utility automotives (operation SUV), buses, trucks, various commercial automotives, watercraft including a variety of boats and ships, aircraft, and the like, and includes hybrid automotives, electric automotives, plug-in hybrid electric automotives, hydrogen-powered automotives and other alternative fuel automotives (e.g., fuels derived from resources other than petroleum). As referred to herein, a hybrid automotive is an automotive that has two or more sources of power, for example both gasoline-powered and electric-powered automotives.

The above and other features of the present disclosure are discussed infra.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 and FIG. 2 are views showing a mounting structure of a charger connection module for a vehicle according to an exemplary embodiment of the present disclosure;

FIG. 3 is a view showing a mounting bracket for the charger connection module according to the exemplary embodiment of the present disclosure;

FIG. 4 is a view showing a partial bonding sequence of the mounting structure of the charger connection module according to the exemplary embodiment of the present disclosure;

FIG. 5 is an enlarged view of a portion of the mounting structure of the charger connection module according to the exemplary embodiment of the present disclosure; and

FIG. 6 is a view showing the mounting structure of the charger connection module according to the exemplary embodiment of the present disclosure from which the charger connection module is omitted.

It should be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in section by the particular intended application and use environment.

In the figures, reference numbers refer to the same or equivalent sections of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Specific structural or functional descriptions presented in the exemplary embodiments of the present disclosure are merely exemplified for describing embodiments according to the concept of the present disclosure, and the exemplary embodiments according to the concept of the present disclosure may be implemented in various forms.

In addition, in the specification, when a certain portion “includes” a certain component, it means further including other components without excluding other components unless especially stated otherwise.

In addition, in the specification, “longitudinal direction” or “horizontal direction” means a direction extending forwards and backwards with respect to a vehicle, “vertical direction” or “height direction” means a direction extending vertically with respect to the vehicle, and “transverse direction” or “width direction” means a direction extending leftward and rightward with respect to the vehicle.

Furthermore, in the specification, “bonding” between components may be performed through welding unless otherwise specified.

Hereinafter, various embodiments of the present disclosure will be described with reference to the accompanying drawings. Matters represented in the accompanying drawings may be the drawings schematically shown to easily describe the exemplary embodiments of the present disclosure and different from those actually implemented.

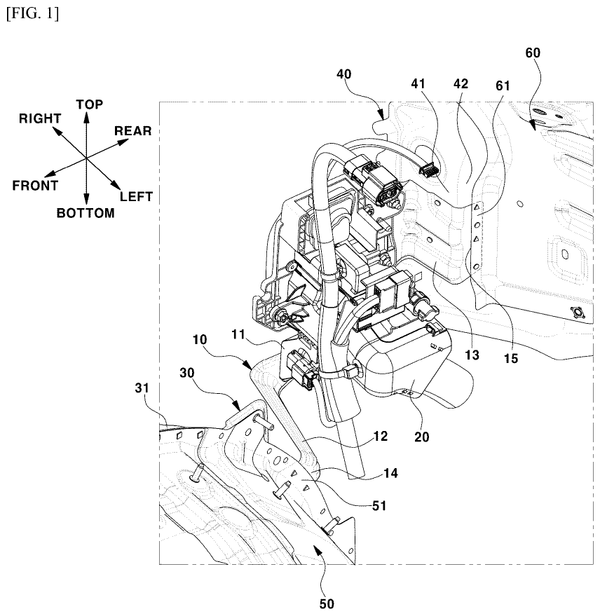

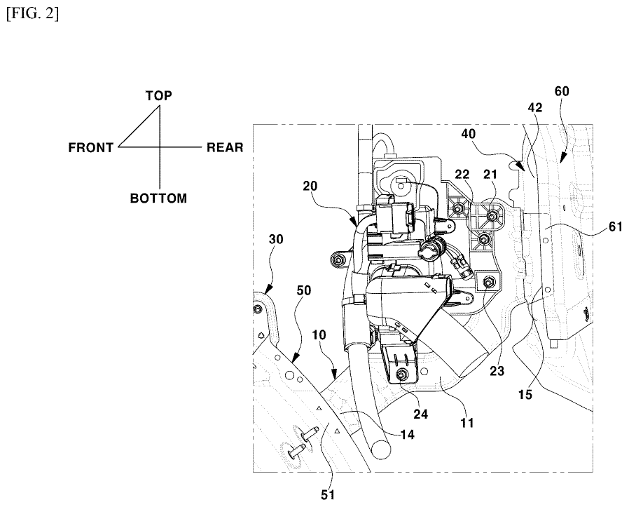

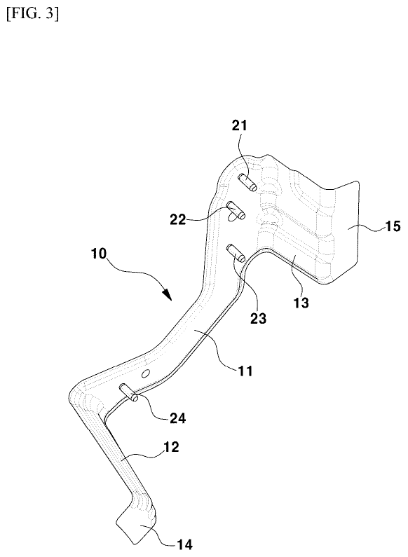

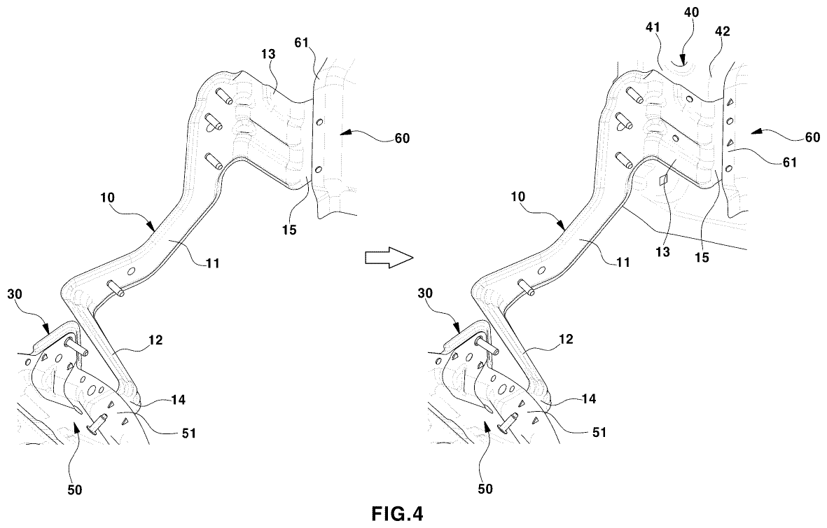

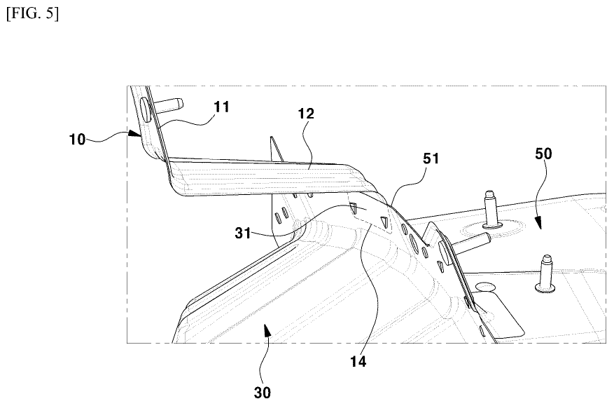

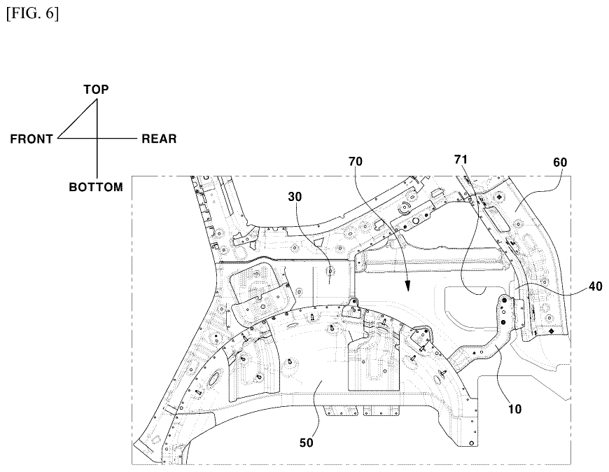

FIG. 1 is a perspective view of a mounting structure of a charger connection module for a vehicle viewed from the interior of the vehicle according to an exemplary embodiment of the present disclosure, and FIG. 2 is a front view of a mounting structure of the charger connection module viewed from the interior of the vehicle. FIG. 3 shows a mounting bracket for the charger connection module according to the exemplary embodiment of the present disclosure, FIG. 4 shows a partial bonding sequence of the mounting structure of the charger connection module, and FIG. 5 is an enlarged view of a portion of the mounting structure of the charger connection module. FIG. 6 is a view showing the mounting structure of the charger connection module according to the exemplary embodiment of the present disclosure from which the charger connection module is omitted. The exemplary embodiment shown in the accompanying drawings shows the mounting structure of the charger connection module applied to a rear right side of a vehicle body.

Reference numeral 10 in FIG. 1 and FIG. 2 indicates a mounting bracket 10 for the charger connection module according to an exemplary embodiment of the present disclosure. Hereinafter, the mounting bracket 10 for the charger connection module will be simply referred to as “mounting bracket 10”.

As shown in FIG. 1 and FIG. 2, the mounting bracket 10 is coupled to a charger connection module 20 to which an external electric charger is selectively connectable. The charger connection module 20 includes a structure in which the electric charger is inserted and electrically connected and is directly mounted to the mounting bracket 10 through a plurality of fastening members 21, 22, 23, and 24. In the instant case, the charger connection module 20 is fastened and mounted to a center portion (i.e., a bracket center portion) of the mounting bracket 10. The fastening members 21, 22, 23, and 24 may use a weld bolt fixedly bonded to a bracket center portion 11 through welding (see FIG. 3).

The mounting bracket 10 is configured to fixedly support the charger connection module 20 to the vehicle body. To the present end, the mounting bracket 10 is coupled to a quarter internal panel 30 and a side external extension panel 40 of the vehicle body. In the instant case, a front portion of the mounting bracket 10 in a longitudinal direction is fixedly bonded to the quarter internal panel, and a rear portion of the mounting bracket 10 in the longitudinal direction is fixedly bonded to the side external extension panel 40 positioned behind the quarter internal panel.

Normally, weights of the charger connection module 20 and wiring components connected to the charger connection module 20 vertically act on the mounting bracket 10. When a battery in the vehicle is charged, a weight of the electric charger inserted into the charger connection module 20 is further applied to the mounting bracket 10 in a vertical direction, and loads in all directions due to the movement, position correction, and the like of the electric charger caused by inserting the electric charger into the charger connection module 20 are also applied to the mounting bracket 10.

Therefore, the mounting bracket 10 is coupled to the quarter internal panel 30, the side external extension panel 40, and the like in a structure including sufficient stiffness and durability to stably support the charger connection module 20 at all times.

Referring to FIG. 3, the mounting bracket 10 is formed as a plate-shaped member having a structure bent in a “ [symbol] ” shape (i.e., an inverted “L” shape), structurally securing stiffness against the load in the longitudinal direction thereof. The mounting bracket 10 includes the bracket center portion 11 on which the charger connection module 20 is mounted, and a bracket front portion 12, a bracket rear portion 13, a front flange 14, and a rear flange 15, which extend in a structure bent from the bracket center portion 11.

The bracket center portion 11 is formed in a plate structure extending in the longitudinal direction and includes a front end portion positioned under a rear end portion in the vertical direction thereof. In other words, the bracket center portion 11 extends in the longitudinal direction and is disposed to extend in an oblique direction rather than in a horizontal direction thereof. Furthermore, the bracket center portion 11 includes a structure substantially bent in a “U” shape.

The bracket front portion 12 is bent and extends from the front end portion of the bracket center portion 11 in the transverse direction, and the bracket rear portion 13 is bent and extends from the rear end portion of the bracket center portion 11 in the same direction as the bracket front portion 12. Referring to FIG. 1, the bracket front portion 12 and the bracket rear portion 13 are bent and extend leftward from the bracket center portion 11.

The front flange 14 is bent and extends from the distal end portion of the bracket front portion 12 in the longitudinal direction, and the rear flange 15 is bent and extends in a direction opposite to the front flange 14. Referring to FIG. 1, the front flange 14 is bent forward from a left distal end portion of the bracket front portion 12, and the rear flange 15 is bent rearward from a left distal end portion of the bracket rear portion 13.

Furthermore, the front flange 14 is inseparably bonded to the quarter internal panel 30 through welding. The front flange 14 is bonded to both of a flange 51 of a wheel housing internal panel 50 and a flange 31 of the quarter internal panel 30.

Referring to FIG. 5, the front flange 14 is directly laminated on the flange 31 of the quarter internal panel 30, and the flange 31 of the quarter internal panel 30 is directly laminated on the flange 51 of the wheel housing internal panel 50. In other words, the front flange 14, the flange 31 of the quarter internal panel 30, and the flange 51 of the wheel housing internal panel 50 are sequentially laminated in the transverse direction thereof. Furthermore, the front flange 14, the flange 31 of the quarter internal panel 30, and the flange 51 of the wheel housing internal panel 50 are bonded simultaneously through welding. In the instant case, the flange 51 of the wheel housing internal panel 50 and the flange 31 of the quarter internal panel 30 extend in the longitudinal direction thereof.

The flange 51 of the wheel housing internal panel 50 is bonded to the flange 31 of the quarter internal panel 30 even in the remaining sections except for a section bonded to the front flange 14.

Meanwhile, the bracket rear portion 13 and the rear flange 15 are inseparably bonded to the side external extension panel 40 through welding. The bracket rear portion 13 is bonded to a transverse extension 41 of the side external extension panel 40 by spot welding, and the rear flange 15 is bonded to a longitudinal extension 42 of the side external extension panel 40. Furthermore, the rear flange 15 is also bonded to a flange 61 of a quarter internal extension panel 60 through spot welding.

Referring to FIG. 4, the rear flange 15 is first laminated and bonded to the flange 61 of the quarter internal extension panel 60 and then laminated and bonded to the longitudinal extension 42 of the side external extension panel 40. When the rear flange 15 is bonded to the longitudinal extension 42, the bracket rear portion 13 is bonded to the transverse extension 41 of the side external extension panel 40. In other words, the rear flange 15 is positioned between the flange 61 of the quarter internal extension panel 60 and the longitudinal extension 42 of the side external extension panel 40 and bonded to both of the flange 61 of the quarter internal extension panel 60 and the longitudinal extension 42.

The side external extension panel 40 includes a structure bent in a “ [symbol] ” shape similar to the mounting bracket 10. The transverse extension 41 of the side external extension panel 40 extends in the same direction as the bracket rear portion 13, and the longitudinal extension 42 of the side external extension panel 40 extends in the same direction as the rear flange 15 and the flange 61 of the quarter internal extension panel 60. The longitudinal extension 42 is bent and extends rearward from a left distal end portion of the transverse extension 41.

As described above, when the mounting bracket 10 is fixedly bonded to the quarter internal panel 30 and the side external extension panel 40, the front flange 14 and the bracket front portion 12 include a lower vertical height than the rear flange 15 and the bracket rear portion 13, respectively. In other words, as shown in FIG. 2, the front portion of the mounting bracket 10 includes a lower vertical height than the rear portion of the mounting bracket 10.

Furthermore, as shown in FIG. 6, each of the quarter internal panel 30 and the side external extension panel 40 is fixedly bonded to the side external panel 70 of the vehicle body. In the instant case, an upper portion of the quarter internal extension panel 60 is bonded to the side external panel 70, and a lower portion of the quarter internal extension panel 60 is bonded to the side external extension panel 40.

The side external panel 70 includes a charging inlet 71 in a predetermined section in which vehicle body components, such as the quarter internal panel 30 and the side external extension panel 40, are not bonded. When the charging inlet 71 is opened, the charger connection module 20 is externally exposed of the vehicle body to enable the connection of the electric charger.

According to an exemplary embodiment of the present disclosure, by mounting the charger connection module 20 to the vehicle body in the mounting structure, it is possible to secure sufficient stiffness and durability capable of withstanding the loads applied to the charger connection module 20 in various directions.

Because the front portion and rear portion of the mounting bracket 10 are respectively bonded to the quarter internal panel 30 and the side external extension panel 40, it is possible to secure the stiffness against the transverse load applied to the mounting bracket 10 and the resistance to the vertical movement of the mounting bracket 10.

Furthermore, because the mounting bracket 10 includes the structure bent in the “ [symbol] ” shape, it is possible to additionally secure the stiffness against the transverse load and the resistance to the vertical movement of the mounting bracket 10.

Furthermore, because the mounting bracket 10 is further bonded to the transverse extension 41 of the side external extension panel 40, it is possible to further secure the resistance to the transverse load and the resistance to the vertical movement of the mounting bracket 10.

Furthermore, because the charger connection module 20 is directly fastened to the mounting bracket 10 through the fastening members 21, 22, 23, and 24, it is possible to secure the resistance to the vertical movement of the charger connection module 20.

Furthermore, because the mounting bracket 10 connecting the quarter lower portion and the extension is configured to reinforce the stiffness of the vehicle body, it is also possible to improve the overall frame of the vehicle body. The quarter lower portion includes the quarter internal panel 30 and the wheel housing internal panel 50, and the extension includes the quarter internal extension panel 60 and the side external extension panel 40.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A mounting structure of a charger connection module for a vehicle, the mounting structure comprising:
a mounting bracket for the charger connection module to which an external electric charger of a vehicle is selectively connectable,
wherein the mounting bracket includes a front portion and a rear portion, and
wherein the front portion of the mounting bracket is attached to a quarter internal panel, and the rear portion of the mounting bracket is attached to a side external extension panel positioned behind the quarter internal panel.

2. The mounting structure of claim 1, wherein the mounting bracket further includes:
a bracket center portion extending in a longitudinal direction of the mounting bracket;
a bracket front portion bent and extending from a front end portion of the bracket center portion in a transverse direction of the mounting bracket;
a bracket rear portion bent and extending from a rear end portion of the bracket center portion in a same direction as the bracket front portion;
a front flange bent and extending forward from a distal end portion of the bracket front portion; and
a rear flange bent and extending rearward from a distal end portion of the bracket rear portion.

3. The mounting structure of claim 2, wherein the front flange is attached to the quarter internal panel.

4. The mounting structure of claim 2, wherein the front flange is attached to a flange of the quarter internal panel and a flange of a wheel housing internal panel attached to the flange of the quarter internal panel.

5. The mounting structure of claim 4, wherein the front flange is directly laminated on the flange of the quarter internal panel, and the flange of the quarter internal panel is directly laminated on the flange of the wheel housing internal panel so that the front flange, the flange of the quarter internal panel, and the flange of the wheel housing internal panel are sequentially laminated.

6. The mounting structure of claim 2, wherein the bracket rear portion is attached to a transverse extension of the side external extension panel.

7. The mounting structure of claim 6, wherein the rear flange is attached to a longitudinal extension of the side external extension panel.

8. The mounting structure of claim 7, wherein the transverse extension extends in a same direction as the bracket rear portion, and the longitudinal extension is bent and extends rearward from a distal end portion of the transverse extension.

9. The mounting structure of claim 7, wherein the rear flange is positioned between the longitudinal extension and a flange of a quarter internal extension panel and attached to the longitudinal extension and the flange of the quarter internal extension panel.

10. The mounting structure of claim 2, wherein the front flange has a vertical height lower than a vertical height of the rear flange.

11. The mounting structure of claim 2, wherein the bracket front portion has a lower vertical height than the bracket rear portion.

12. The mounting structure of claim 2, wherein the bracket center portion includes a structure bent in a “U” shape.

13. The mounting structure of claim 2, wherein the bracket center portion extends in the longitudinal direction and is formed to extend in an oblique direction at the front end portion and the rear end portion of the bracket center portion.

14. The mounting structure of claim 2, wherein the charger connection module is mounted on the bracket center portion through a plurality of fastening members.

15. The mounting structure of claim 14, wherein each of the fastening members includes a weld bolt fixedly bonded to the bracket center portion through welding.

16. The mounting structure of claim 9, wherein the quarter internal panel and the side external extension panel are attached to a side external panel.

17. The mounting structure of claim 16, wherein an upper portion of the quarter internal extension panel is attached to the side external panel, and a lower portion of the quarter internal extension panel is attached to the side external extension panel.

18. The mounting structure of claim 1. wherein the mounting bracket has a structure bent in a shape of “L”.
